(19) United States
(12) Patent Application Publication
(10) Pub. No.: US 2009/0010110 A1
(43) Pub. Date: Jan. 8, 2009

(54) Camouflage Wrist Watch Protection Apparatus

(76) Inventor: Lawrence Chariton, Massapequa, NY (US)

Correspondence Address: LAWRENCE CHARITON, 30 ROCKAWAY PLACE, MASSAPEQUA, NY, 11758, US

(21) Appl. No.: 11/774,235

(22) Filed: Jul. 6, 2007

(51) Int. Cl. G04B 37/18

(52) U.S. Cl. 368/283

(57) ABSTRACT

A wrist watch covering includes a bottom panel, a first panel and a second panel. The first panel is attached to the bottom panel with a first and second fastener attached thereto. The second panel is attached to the bottom panel, with a third and fourth fastener attached thereto. A cavity between the first panel and the bottom panel and between the second panel and the bottom panel receives a wrist watch such that the second panel covers a face of the wrist watch when the third fastener is mated with the second fastener. The first fastener mates with the fourth fastener and forms a loop.

### BACKGROUND OF THE INVENTION

1. Technical Field

The present disclosure relates to wrist watches and, more specifically, to an apparatus for wrist watch camouflage.

2. Discussion of the Related Art

The modern wrist watch includes a band that is worn around the wrist with a time piece at the face of the wrist watch for conveniently ascertaining the time of day and other useful information. The band may be constructed of various materials including flexible materials such as plastic and leather and/or links of ridged materials such as metal. Stainless steal is commonly used in watch bands; however, precious metals such as gold may be used for added luxury. Accordingly, wrist watch bands may be highly reflective, especially when constructed of metal.

Regardless of the composition of the band, the wrist watch time piece is generally highly reflective, often including a transparent face constructed of glass or crystal that is prone to reflecting light. Additionally, many fine time pieces incorporate luminous stones and/or polished metal surfaces. Moreover, wrist watch time pieces may include a metallic bezel, often matching a metallic band.

While maintaining awareness of the time of day is particularly important when conducting military operations, the reflective properties of a soldier's wrist watch may inadvertently reveal the soldier's position during clandestine operations. During such operations, soldiers often wear camouflage clothing and may take steps to minimize visibility by ensuring that they adequately blend in to their surroundings. On such occasions, it may be difficult or impossible to properly camouflage a wrist watch.

Camouflage is also used when hunting. As game may be receptive to flashes of light, a hunter's wrist watch may accidentally scare off game as sunlight is reflected in unpredictable ways.

Moreover, even the most durable wrist watches may be susceptible to scuffing and scratching when used during outdoors activities. A user wishing to keep a wrist watch free from dirt and possible damage may avoid wearing a wrist watch during outdoor activities and may therefore be deprived of its use when it is most needed.

When used in sports, in addition to being vulnerable to damage, a wrist watch may inadvertently injure a player during physical contact.

### SUMMARY

A wrist watch covering includes a bottom panel, a first panel and a second panel. The first panel is attached to the bottom panel with a first and second fastener attached thereto. The second panel is attached to the bottom panel, with a third and fourth fastener attached thereto. A cavity between the first panel and the bottom panel and between the second panel and the bottom panel receives a wrist watch such that the second panel covers a face of the wrist watch when the third fastener is mated with the second fastener. The first fastener mates with the fourth fastener and forms a loop.

A method for covering a wrist watch includes placing a wrist watch between a first panel and a bottom panel and between a second panel and a bottom panel. A band of the wrist watch is closed around a wrist of a user. The first panel and the second panel are closed around the wrist of the user.

A wrist watch covering includes a first panel and a second panel that attach at one end over a face of a wrist watch and attach at an opposite end to form a loop around a wrist of a user.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a side view of the protective apparatus laid out flat according to an exemplary embodiment of the present invention;

FIG. 2 is a side view of the protective apparatus encircled according to an exemplary embodiment of the present invention;

FIG. 3 is a perspective view of the protective apparatus laid out flat according to an exemplary embodiment of the present invention;

FIG. 4 is a perspective view of the protective apparatus encircled according to an exemplary embodiment of the present invention; and

FIG. 5 is a flow chart showing a method for applying wrist watch coverings according to exemplary embodiments of the present invention.

### DETAILED DESCRIPTION OF THE DRAWINGS

In describing the exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention provide a wrist watch covering comprising a protection apparatus that may conceal and protect a wrist watch when used in circumstances such as those discussed above. Exposed surfaces of the wrist watch may have a camouflage pattern, may be a solid color, such as black, or may have a decorative design or logo. A wrist watch may be freely inserted into and removed from the protection apparatus.

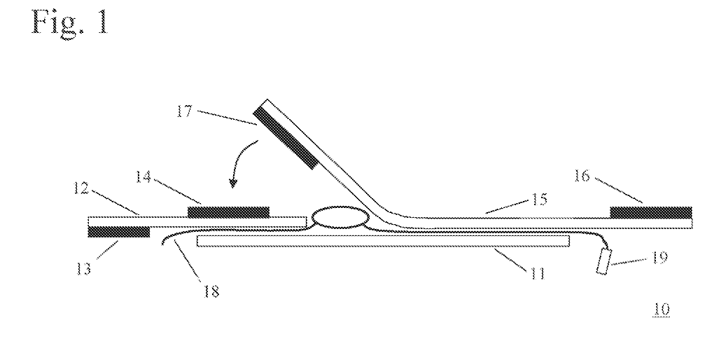

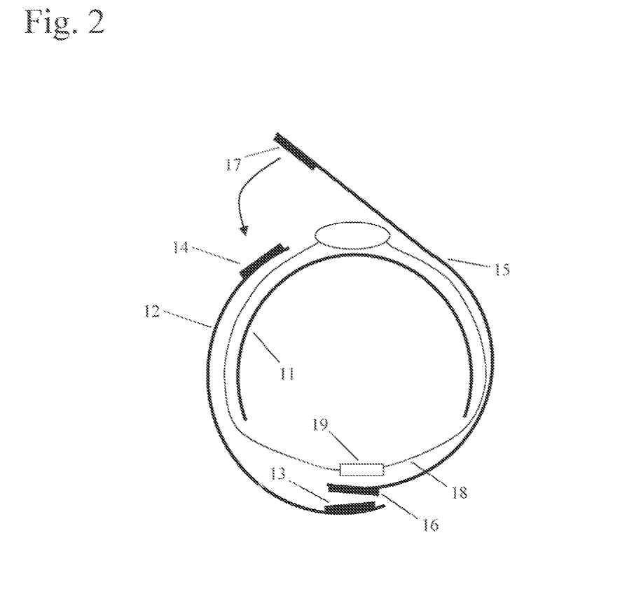

FIGS. 1 and 2 are diagrams showing a wrist watch and a protective apparatus according to an exemplary embodiment of the present invention. In these figures, the various constituent parts may not be drawn to scale. Moreover, while some constituent parts are referred to as “left” parts or “right” parts, “front” parts or “back” parts, these designations only refer to the illustrated orientation and the protective apparatus may be made in any orientation, for example, as a mirror image of the way shown. FIG. 1 is a side view of the protective apparatus laid out flat while FIG. 2 is a side view of the protective apparatus encircled. The protective apparatus 10 includes a bottom panel 11. The bottom panel 11 may be breathable and soft where added user comfort is desired. A left panel 12 may cover a left portion of the bottom panel 11. The left panel 12 may be attached to the bottom panel 11, for example, at a front seam and a back seam. Accordingly, a passage between the left panel 12 and the bottom panel 11, and between the front seam and the back seam, may allow for a left side of a band of a wrist watch 18 to slide through.

A first fastener 13 may foe included on a lower surface of the left panel 12. A second fastener 14 may be included on an upper surface of the left panel 12.

A right panel 15 may cover a right portion of the bottom panel 11. The right panel 15 may be attached to the bottom panel 11, for example, at a front seam and a back seam. Accordingly, a passage between the right panel 15 and the bottom panel 11, and between the front sears, and the back seam, may allow for a right side of the band of the wrist watch 18 to slide through. The band of the wrist watch 18 may include a buckle 19. The buckle 19 may be located at ether end of the band.

A third fastener 17 may be included on a lower surface of the right panel 15. A fourth fastener 16 may be included on an upper surface of the right panel 15.

The second fastener 14 may mate with the third fastener 17 to close over a time piece of the wrist watch 18 and thus allow the right panel 15 to protect and conceal the time piece. To accommodate a large time piece, the right panel 15 may include slack. Moreover, by using relatively large and/or adjustable fasteners 14 and 17, the degree of slack in the right panel 15 may be adjusted to accommodate time pieces of various sizes. Similarly, the first fastener 13 may mate with the fourth fastener 16 to form a loop and encircle the user's wrist. Again, by using relatively large and/or adjustable fasteners 13 and 16, the fit of the protective apparatus 10 about the wearer's wrist may be adjusted. The wrist watch buckle 19 may be fastened prior to mating the first fastener 13 to the fourth fastener 16.

The fasteners 13, 14, 16 and 17 may use one or more of a variety of re-attachable fastening technologies. For example, the fasteners 13, 14, 16 and 17 may include Velcro™. Alternatively, other fastening technologies such as buckles, buttons, snaps, zippers, magnetic fasteners and the like may be used.

The panels 11, 12 and 15 may be made of a synthetic or natural textile, for example, a cotton or nylon fabric. While any surface of any panel 11, 12 and 15 may be camouflaged or otherwise adorned with the desired color, pattern or image; to minimize manufacturing costs, patterning may be limited to particular surfaces and/or panels. For example, patterning may be limited to top surfaces of the left 12 and right 15 panels or the exposed areas thereof.

While any color, pattern or image may be used, examples of commonly used military camouflage patterns include: MARPAT, ACUPAT, MultiCam, Six-Color Desert Pattern, etc.

Exemplary embodiments used for hunting may use a brightly colored camouflage such as orange to simultaneously allow for greater visibility by other hunters while providing for adequate camouflage by game that lack the ability to distinguish color.

Exemplary embodiments of the present invention may also be used to enhance visibility by incorporating bright colors and/or reflective materials. Such exemplary embodiments may be used, for example, when walking or riding a bicycle at night.

While some wrist watches, as described above, include a band that includes a left band and a right band that interlock using a buckle, other wrist watches, particularly those with metallic bands, do not use a buckle and instead include a latch that loosens the band enough to fit over the hand and then tightens the band around the wrist. Such bands may not be separable and thus may not easily fit into the protective apparatus as described above. Accordingly, exemplary embodiments of the present invention allow for the accommodation of wrist watches with bands that do not separate.

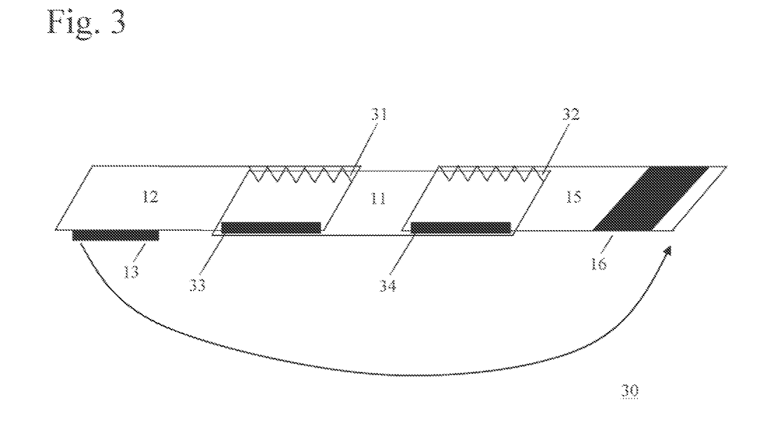

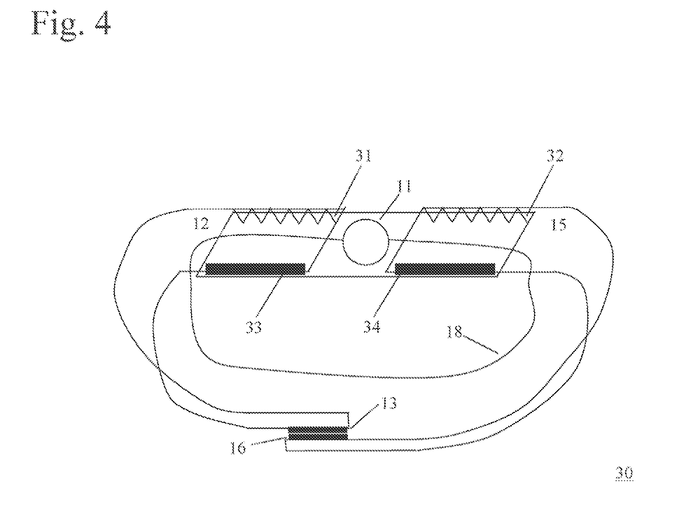

FIGS. 3 and 4 are a diagram showing a perspective view of a protective apparatus according to an exemplary embodiment of the present invention. FIG. 3 is a perspective view of the protective apparatus laid out flat while FIG. 4 is a perspective view of the protective apparatus encircled. The embodiment illustrated in FIGS. 3 and 4 may share many aspects with the protective apparatus shown in FIGS. 1 and 2, and those features not described with reference to FIGS. 3 and 4 may be assumed to be identical or similar to features of FIGS. 1 and 2 described above.

The protective apparatus 30 includes a bottom panel 11, a left panel 12 and a right panel 15. The left panel 12 may be permanently attached to the bottom panel 11 at a single seam. For example, a back seam 31 may include stitching, gluing or some other permanent attaching technology. A front seam 33 may include a re-attachable fastening technology such as Velcro™, buckles, buttons, snaps, zippers, magnetic fasteners and the like.

Similarly, the right panel 15 may be permanently attached to the bottom panel 11 at a single seam. For example, a back seam 32 may include stitching, gluing or some other permanent attaching technology. A front seam 34 may include a re-attachable fastening technology.

A wrist watch with a band that does not separate may be inserted into the protective apparatus 30, for example, while the re-attachable front seams 33 and 34 are in an opened state.

After the wrist watch has been inserted, the re-attachable seams 33 and 34 may be closed around the wrist watch. The wrist watch may then be placed on the wrist and securely latched in the normal manner, at which point, the protective apparatus 30 may be closed about the wrist by mating the first 13 and fourth 16 fasteners.

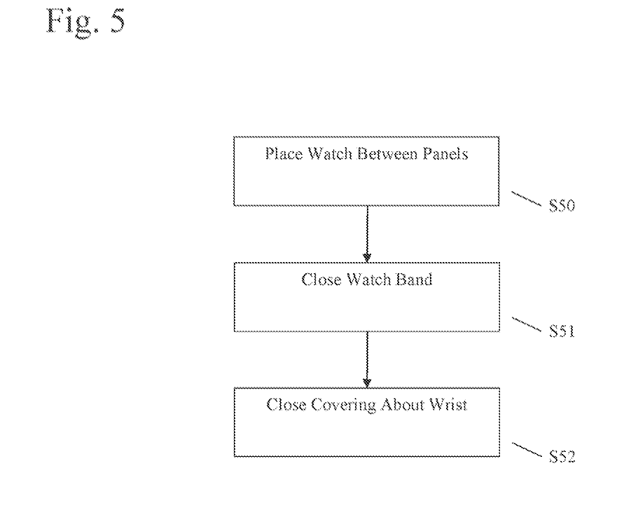

FIG. 5 is a flow chart showing a method for applying wrist watch coverings according to exemplary embodiments of the present invention. First, the watch may be inserted into the space between the right panel 12 and the bottom panel 11 and between the left panel 15 and the bottom panel 11 (Step S50). Where the panels have seams that may be detached and reattached, the re-attachable seams may be open to accommodate the insertion of the watch. The watch band may then be closed around the wrist of the user (Step S51). Where the watch band is in two parts, closing the watch band may include buckling or otherwise attaching the two parts of the band. Where the watch band is in one part that loosens to fit over the hand of the user and then tightens around the wrist, closing the watch band may include tightening the band, for example, using a latch or some other tightening arrangement. Finally, the watch covering may be closed around the wrist (Step S52). The watch covering may close around the wrist on top of the watch band. As described above, fasteners may be used to close the covering about the wrist. These fasteners may be relatively large and/or adjustable to fit securely around wrists and watches of varying size.

The above specific exemplary embodiments are illustrative, and many variations can be introduced on these embodiments without departing from the spirit of the disclosure or from the scope of the appended claims. For example, elements and/or features of different exemplary embodiments may be combined with each other and/or substituted for each other within the scope of this disclosure and appended claims.

What is claimed is;

1. A wrist watch covering, comprising:
a bottom panel;
a first panel attached to the bottom panel, with a first and second fastener attached thereto;
a second panel attached to the bottom panel, with a third and fourth fastener attached thereto;
a cavity between the first panel and the bottom panel and between the second panel and the bottom panel for receiving a wrist watch such that the second panel covers a face of the wrist watch when the third fastener is mated with the second fastener, and the first fastener mates with the fourth fastener for forming a loop.

2. The wrist watch covering of claim 1, wherein the second and third fasteners are Velco fasteners.

3. The wrist watch covering of claim 1, wherein the second and third fasteners are snap fasteners.

4. The wrist watch covering of claim 1, wherein the first and fourth fasteners are Velco fasteners.

5. The wrist watch covering of claim 1, wherein the first and fourth fasteners are snap fasteners.

6. The wrist watch covering of claim 1, wherein the first panel is attached to the bottom panel by a first seam and a second seam, and the second panel is attached to the bottom panel by a first seam and a second seam, wherein the first seams are re-attachable and the second seams are not re-attachable.

7. The wrist watch covering of claim 6, wherein the first seams comprise Velcro fasteners.

8. The wrist watch covering of claim 6, wherein the first seams comprise snap fasteners.

9. The wrist watch covering of claim 6, wherein a band of the wrist watch is not separable.

10. The wrist watch covering of claim 1, wherein one or more of the first panel, second panel, and bottom panel comprise a camouflage pattern.

11. The wrist watch covering of claim 1, wherein one or more of the first panel, second panel, and bottom panel comprise a reflective material.

12. The wrist watch covering of claim 1, wherein one or more of the first panel, second panel, and bottom panel comprise a reflective material.

13. The wrist watch covering of claim 1, wherein one or more of the first panel, second panel, and bottom panel are brightly colored.

14. A method for covering a wrist watch, comprising:
placing a wrist watch between a first panel and a bottom panel and between a second panel and a bottom panel;
closing a band of the wrist watch around a wrist of a user; and
closing the first panel and the second panel around the wrist of the user.

15. The method of claim 14, wherein a face of the wrist watch is revealed by separating the second panel from the first panel and the face of the wrist watch is concealed by connecting the second panel to the first panel.

16. The method of claim 14, wherein the watch is placed between the first panel and the bottom panel and between the second panel and the bottom panel when a seam connecting the first panel to the bottom panel and a seam connecting the second panel to the bottom panel are opened.

17. The method of claim 16, wherein the seams are closed to secure the watch between the first panel and the bottom panel and between the second panel and the bottom panel.

18. The method of claim 14, wherein closing the band of the wrist watch around the wrist of the user comprises connecting two separate portions of the band.

19. The method of claim 14, wherein closing the band of the wrist watch around the wrist of the user comprises closing a latch to tighten the band about the wrist.

20. A wrist watch covering, comprising:
a first panel and a second panel that attach at one end over a face of a wrist watch and attach at an opposite end to form a loop around a wrist of a user.
